(19) United States
(12) Patent Application Publication
(10) Pub. No.: US 2004/0043810 A1
(43) Pub. Date: Mar. 4, 2004

(54) Providing a contest and obtaining marketing data therefrom

(76) Inventors: Ari S. Perlin, Los Angeles, CA (US); Lucio Nino Rossi, Los Angeles, CA (US); Lei Pan, Duarte, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/232,026

(22) Filed: Aug. 30, 2002

(51) Int. Cl. A63F 9/24; A63F 13/00; G06F 17/00; G06F 19/00

(52) U.S. Cl. 463/16

(57) ABSTRACT

Providing a contest and obtaining marketing data therefrom. A method includes offering an event prediction contest. An event prediction contest ballot and at least one advertisement is provided to a participant. In one embodiment, a participant selection of an advertisement is required to and is received to submit a completed ballot. A participant selected advertisement is presented to the participant for a time period. The completed ballot is entered in the prediction contest after the advertisement has been displayed for the time period, and the ballot is not entered if the participant disengages the advertisement before the time period expires. Responses to survey questions may be required to submit the contest ballot. A participant profile is maintained based on responses to the survey questions. The advertisement may be provided based on the participant profile. The method may be implemented on a computer connected to a network.

### BACKGROUND OF THE INVENTION

1. Field

This invention relates to contests that allow for recovering marketing data based on responses to survey questions and website usage, and the computer and other systems which may implement the contests which are accessible via a network.

2. Background

With the ever-growing popularity of the Internet, people are using the Internet for recreation and entertainment. Sports fans track their favorite teams and players via various websites and participate in fantasy leagues on-line. Other fans of other forms of entertainment such as films and television may also keep track of their favorite stars, movies and programs via websites provided on the Internet. In addition to providing entertainment and information, websites may also provide trivia contests that add to the recreational pleasure of Internet users. Another form of Internet entertainment which parallels its popularity off line are the various websites that provide lotteries and other games of chance.

### SUMMARY

Providing a contest and obtaining marketing data therefrom. A method includes offering an event prediction contest. An event prediction contest ballot and at least one advertisement is provided to a participant. In one embodiment, a participant selection of an advertisement is required to and is received to submit a completed ballot. A participant selected advertisement is presented to the participant for a time period. The completed ballot is entered in the prediction contest after the advertisement has been displayed for the time period, and the ballot is not entered if the participant disengages the advertisement before the time period expires. Responses to survey questions may be required to submit the contest ballot. A participant profile is maintained based on responses to the survey questions. The advertisement may be provided based on the participant profile. The method may be implemented on a computer connected to a network.

### BRIEF DESCRIPTION OF THE DRAWINGS

FIG. 1 illustrates an overview of a flow of actions of an embodiment of a prediction contest website.

FIGS. 2A and 2B illustrate a flow of actions taken to receive a prediction contest ballot according to an embodiment of the prediction contest website described herein.

FIG. 2C illustrates a flow of actions taken to process a prediction contest ballot according to an embodiment of the prediction contest website described herein.

FIG. 3 illustrates an example prediction contest main web page according to an embodiment of the invention described herein.

FIGS. 4A, 4B, and 4C illustrate an example prediction ballot web page according to an embodiment of the invention described herein.

FIG. 5A illustrates an advertiser website accompanied by a countdown timer window according to an embodiment of the invention described herein.

FIG. 5B illustrates a ballot submitted notification window according to an embodiment of the invention described herein.

FIG. 5C illustrates a ballot not submitted notification window according to an embodiment of the invention described herein.

FIG. 6A illustrates a raffle web page according to an embodiment of the invention described herein.

FIG. 6B illustrates a leaderboard web page according to an embodiment of the invention described herein.

FIGS. 7A and 7B illustrate group play web pages according to an embodiment of the invention described herein.

FIG. 8 illustrates an environment in which an embodiment of the prediction contest described herein may be implemented.

### DETAILED DESCRIPTION

The invention described herein involves, in one embodiment, providing a website that allows Internet users to participate in contests for prizes which increase in value based on the number of users who participate in the contest selected. In one embodiment, the kinds of contests involve predicting the outcome of sporting events. Other embodiments involve other kinds of skill or knowledge based contests, such as, for example, trivia contests. In one embodiment, the contest website described herein requires a participant in a contest to view an advertisement as a prerequisite for submission of the prediction contest ballot. Also, included in the ballots are one or more survey questions. In one embodiment, the survey questions must be answered as a prerequisite for submission of a contest ballot. In this embodiment, the contest website uses responses to the survey questions, participant registration information, and other information to maintain a participant profile in a participant database that allows for directed marketing of advertising and solicitations to participants.

In one embodiment, a contest may be designated a perfect ballot contest or a best ballot contest. To win a perfect ballot prediction contest, a participant must accurately select all outcomes of a particular grouping of events. To win a best ballot prediction contest, a participant must submit a ballot which is awarded the greatest number of tickets based on the correctly predicted outcomes of a series of events when compared to all other participants. In this embodiment, single tickets may be awarded for each prediction of a prevailing team, while three tickets may be awarded when a tie is correctly predicted. As such, a ballot with more correct predictions may earn fewer points than a ballot accurately predicting a tie. In another embodiment, the winner of a best ballot prediction contest may be the participant who submitted a ballot having the greatest number of correctly predicted outcomes of a series of events when compared to all other participants. With any contest, when there are multiple winners, tie breaker questions included in the ballot are used to break the tie. In one embodiment, a random drawing may be held when multiple winning ballots have equal success on the tie breaker questions.

In one embodiment, the contest website also allows participants to create or participate in groups of other participants interested in a single sport or league, or interested in all sports to see how they fare among others in their group. In addition, groups may view how they fare in comparison to other groups in how they succeed in the contests. In one embodiment, a further classification of groups into categories may be made so that groups may participate in a category against other groups, such as, for example fraternities from a school may form groups within the category fraternities from school XYZ. That is, the fraternities at a particular school, such as U.C.L.A. may form groups which are included in the category U.C.L.A. fraternities, where each group includes students affiliated with a specified fraternity. In one embodiment, categories may only be created by a website manager or operator, while groups may be created by any website participant. In other embodiments, multiple levels of competition may be provided by adding additional levels of groups, categories, and the like.

In one embodiment, the contests involve predicting the outcome of sporting events such as sporting games, matches, etc. affiliated with major leagues, minor leagues, and associations such as the National Basketball Association (NBA), Major League Baseball (MLB), National Collegiate Athletic Association (NCAA) sports, Major League Soccer (MLS), National Association for Stock Car Auto Racing (NASCAR), and the like. The prediction contests may include team sports such as baseball and football which may require a participant to select the outcome of a group of games on a particular day, as well as individual participant sports such as golf, tennis, cycling, etc. which may require a participant to select an order of a group of top finishers. Prediction contests may also involve selecting the winners of a tournament such as soccer's World Cup, a playoff series, a group of Olympic medallists, the winners of a track meet, etc. In other embodiments, the event prediction contest may involve awards such as the Grammy Awards, Academy Awards, Emmy Awards, and the like. In yet other embodiments, the prediction contest may involve predicting the outcome of television programs or events such as soap opera character relationships; “Survivor”, “American Idol”, and other reality television show participant finishers; and the outcome of actual or fictional television programs and events.

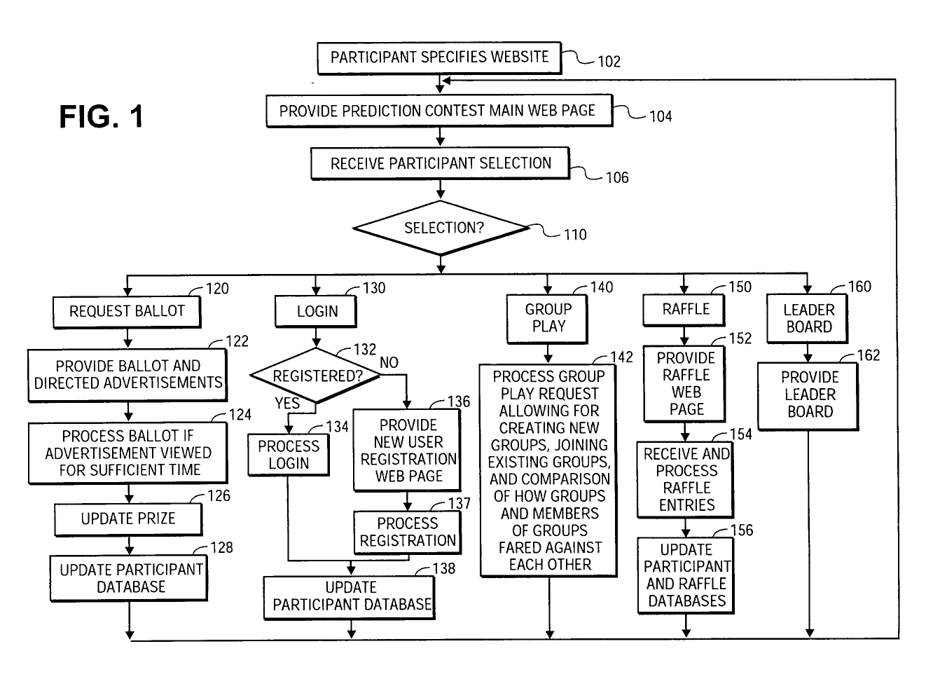

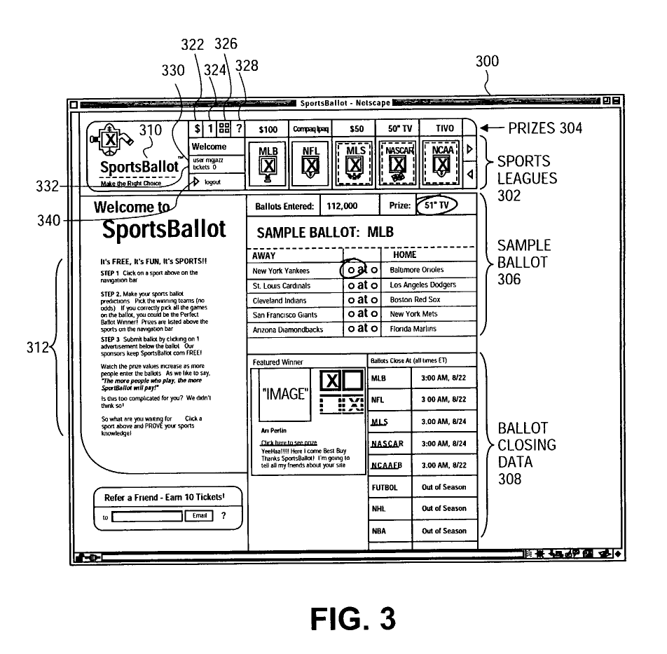

FIG. 1 illustrates an overview of a flow of actions of an embodiment of a prediction contest website. It will be appreciated that more or fewer blocks and processes may be incorporated into the method illustrated in FIG. 1 and the other figures described herein without departing from the scope of the invention. Further, no particular order is implied by the arrangement of blocks shown and described with regard to FIG. 1 and the other figures described herein. Referring to FIG. 1, a participant specifies a prediction contest website, as shown in block 102. The prediction contest website provides the prediction contest main web page to the participant, as shown in block 104. A sample prediction contest main web page is described below with regard to FIG. 3. The prediction contest website may receive a participant's selection, as shown in block 106. The actions taken by the prediction contest website are then based on the participant's selection, as shown in block 110.

When a participant makes a selection to request a prediction contest ballot, as shown in block 120, the prediction contest website provides a ballot and advertisements to the participant, as shown in block 122. As will be described in more detail below, the advertisements may be directed to a participant based on a participant profile stored and maintained in a participant database. The ballot may be processed if a participant selected advertisement is viewed for a sufficient time period, as shown in block 124. In one embodiment, a ballot database may be updated based on the submitted ballot. In one embodiment, the prize which may be awarded to a winner of a contest may be increased in value by the prediction contest website based on the number of participants in the prediction contest. The prize may be updated in response to receiving a participant ballot, as shown in block 126. The participant database is also updated based on a survey question contained in the prediction contest ballot, as shown in block 128.

When the participant selects to login, as shown in block 130, the prediction contest website asks whether the participant would like to create a new login name by registering with the system or whether the participant is already a registered user, as shown in block 132. If the participant is a currently registered user, the login is processed, as shown in block 134. If the participant is a new user, a new user registration web page is provided, as shown in block 136. The new user registration or existing user login is processed and the participant database is updated accordingly, as shown in block 138. Registration information required of a participant may include name, mailing address, telephone number, favorite sport, email address, login name, password, and whether the participant would like to receive email advertisements or solicitations from sponsors. Other, less, and additional registration information may be required in various embodiments, such as, for example, date of birth, education level, sex, household income, etc. Initially, a participant profile is created that includes only the information obtained during participant registration. As the participant enters contests and raffles as described herein, the participant profile is updated and continues to grow.

When the participant selects the group play feature of the prediction contest website, as shown in block 140, the prediction contest website processes the group play request and allows for the creation of a group for comparison of how one group fared versus other groups and how members of a group fared versus each other in prediction contests, as shown in block 142.

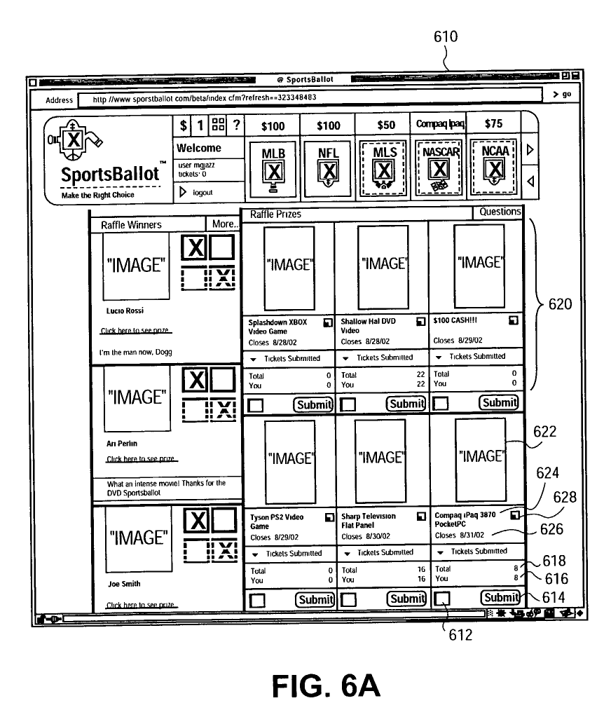

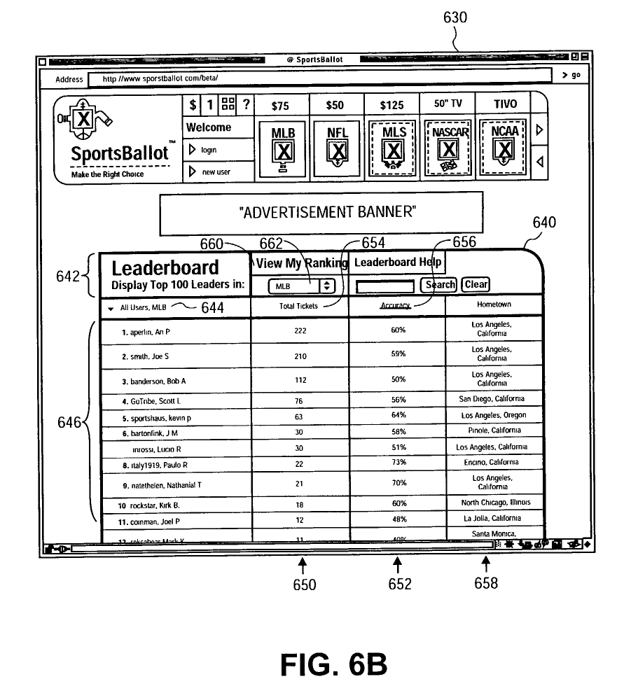

When a participant selects to access the raffle feature of the prediction contest website, as shown in block 150, the prediction contest website provides a raffle web page, as shown in block 152. When a participant enters into a prediction contest and does not win the prediction contest, the participant may be awarded tickets, points, credits, or other similar reward based on the number of events or finishes correctly predicted. The participant may then use the tickets to enter one or more raffles for prizes. An example raffle web page is illustrated in FIG. 6A which is discussed below. The prediction contest website receives and processes raffle entries, as shown in block 154. The prediction contest website updates a raffle database and/or the participant database, as shown in block 156, based on those raffles which the participant chose to enter. In various embodiments, one or more databases may be maintained to store raffle entries and participant profile information. When more than one database is used, the databases may be aligned or otherwise connected via relational and other well known database techniques. The raffle entries may be used to derive or extrapolate information used to maintain a participant profile. For example, the participant profile may be updated to reflect whether the participant selected a music CD, a movie DVD, a DVD player, a store gift certificate, a weekend getaway package, or other prizes as well as the details regarding the particular prize from which marketing information may be derived. Marketing data such as, for example, whether the participant prefers music over movies, or a first kind of movie over a second kind of movie may be derived from raffle entries placed according to data matching techniques and added to a participant profile.

When a participant selects to access the leaderboard features at the prediction contest website, as shown in block 160, a leaderboard web page is provided, as shown in block 162. The leaderboard web page allows a participant to view a list of participants who are the most accurate predictors and who have won the most tickets. An example leaderboard web page is provided in FIG. 6B discussed below.

Once a participant's selection has been processed according to the preceding paragraphs, the flow of actions continues at block 104 where the main web page is again provided to the participant.

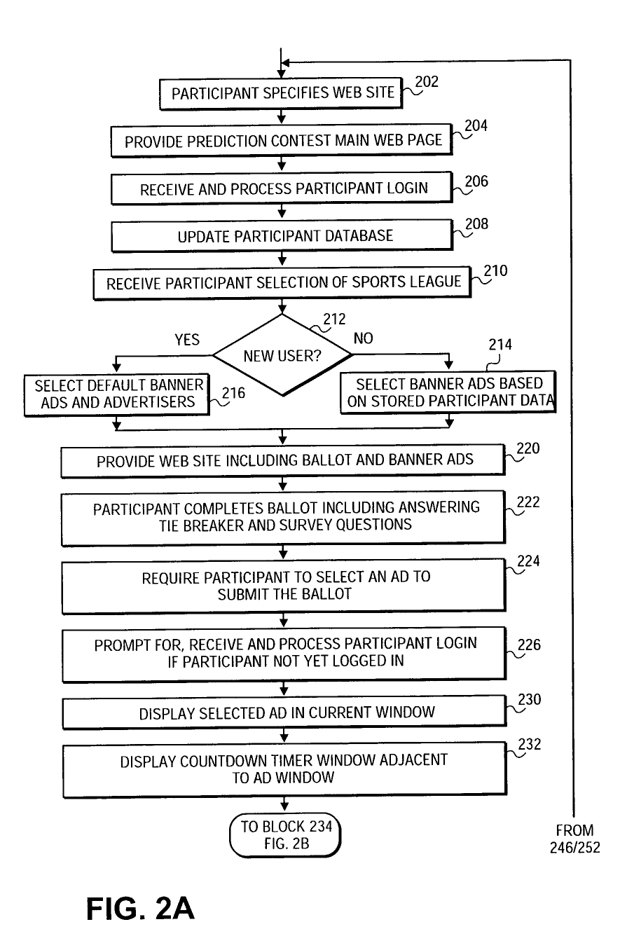

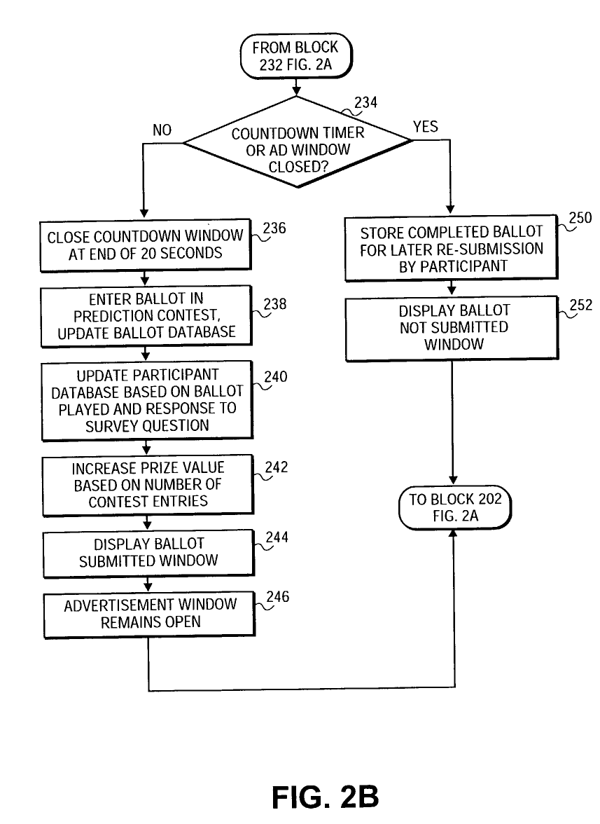

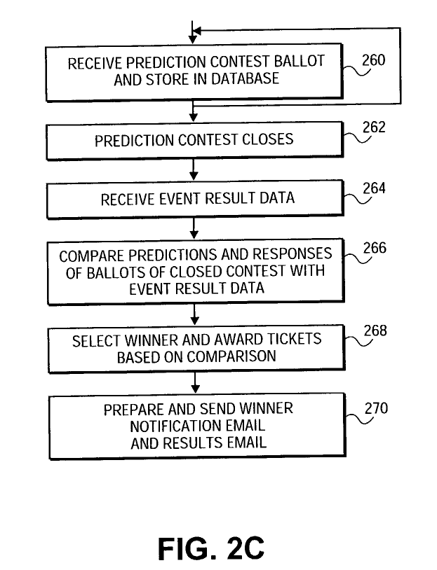

FIGS. 2A and 2B illustrate a flow of actions taken to receive a prediction contest ballot according to an embodiment of the prediction contest website described herein. After a participant specifies the prediction contest website, as shown in block 202, the prediction contest website provides the prediction contest main web page, as shown in block 204. Depending on how the participant proceeds, the prediction contest website may receive and process a participant login request, as shown in block 206. If the participant chooses to login at this time, the prediction contest website updates the participant database based on the participant registration or login information, as shown in block 208. The prediction contest website may receive a participant's selection of a sports league, as shown in block 210. The prediction contest website then does a check to determine whether the current user is a new user, as shown in block 212. If the participant is not a new user, the flow of actions continues at block 214 in which the prediction contest website selects one or more banner ads based on stored participant data, such as that stored in the participant profile. These selected banner ads may be referred to as directed ads. If the participant has not yet logged in or is a new user, the flow of actions continues at block 216 where the prediction contest website selects one or more default banner ads. After blocks 214 or 216, the flow of actions continues at block 220 in which the prediction contest website provides a web page including a prediction contest ballot and associated banner ads, as shown in block 220. The associated banner ads are either the default banner ads from block 216 or the directed banner ads from block 214. The participant may complete the prediction contest ballot, including answering tie breaker and survey questions included in the ballot, as shown in block 222. In one embodiment, the survey questions included in a ballot may be based on participant profile information, such as for example, income level, sex, sport most liked, kind of music most liked, kind of movie most liked, etc. The survey questions asked may seek demographic and other information about a participant, such as plans to purchase specified products and services, entertainment and dining preferences, etc. The survey question responses may be used to build participant profiles. In one embodiment, the prediction contest website may receive income for placing survey questions in ballots as requested by third party manufacturers and service providers.

In one embodiment, the prediction contest requires that the participant select an ad to effectuate submission of the ballot, as shown in block 224. When an ad is selected, the prediction contest website prompts a participant to log in or register if the participant has not yet logged in, and receives and processes the participant login or registration, as shown in block 226. The advertisement selected by the participant is displayed in the current window, as shown in block 230. In one embodiment, the advertisement may be a web page, a graphic image, a short video, or any other kind of ad. The ad may be served by the advertiser or a third party ad serving entity. In one embodiment, the ad may simply be the home page of an advertiser. Concurrently, a countdown timer window is displayed in a window adjacent to the advertisement window, as shown in block 232. The prediction contest website counts down a system defined period of time such as, for example, 20 seconds. In various embodiments, various time periods may be used, such as , for example, five seconds, 10 seconds, etc. The time periods for each contest or advertiser may vary and may be set by a prediction contest website manager. By providing this countdown time, the participant knows that the advertisement window must remain open for the particular period of time for submission of the ballot to be processed. A check is made to determine whether either the countdown timer window or the advertisement window has been closed during this time period, as shown in block 234.

If the advertisement window is kept open until the countdown timer has expired, the countdown timer window is closed at the end of this time period, as shown in block 236. The participant's ballot is entered in the prediction contest, and a ballot database is updated as shown in block 238. The prediction contest website updates the participant database reflecting the sport selected by the participant and in response to the survey questions provided by the participant in the ballot, as shown in block 240. In one embodiment, the prediction contest website increases the prize value based on the number of contest entries, as shown in block 242. That is, the number of participants in the particular contest is incremented, and, if a system defined threshold or level is met, the prize for the particular contest may be increased. In general, the more participants in a contest, the larger the prize grows. For example, an administration module may allow the prediction contest manager to set up a contest in which the dollar value of a contest prize is automatically increased by $25.00 for each entry received. In other embodiments, other prize increases may be made in response to reaching certain levels of participation in the contest. For example, a contest may be provided in which a prize may be increased by $25.00 for each 1,000 entries. In another example, a contest may be provided in which a prize may be increased $100.00 for each 1,000 entries received up to 10,000, and thereafter, the prize may be increased $1.00 per every 1,000 entries received. Some contests may have a cap or maximum beyond which the prize will not grow. Various other schemes may be used in increasing the prize received based on the number of participants in a contest. Contests may also be provided which have a constant, unchanging prize such as a dollar amount, for example, $10,000 and $200,000.00, a vacation package, a television system, a computer, a camera, and the like. The prediction contest website may notify a participant that the ballot has been processed and submitted by displaying a ballot submitted window, as shown in block 244. The advertisement window remains displayed on the participant's computer screen at the completion of the processing of the prediction contest ballot, as shown in block 246. The flow of actions continues by looping back to block 202.

If the advertisement window is closed before the countdown timer has expired, or if the countdown timer window is closed before the countdown timer has expired, as shown in block 234, the ballot is not entered into the contest. The prediction contest website may store the completed but unsubmitted ballot for later submission by the participant, as shown in block 250. A ballot not submitted window is displayed, as shown in block 252, informing the would be participant that the ballot has not been submitted. The flow of actions continues by looping back to block 202.

In another embodiment, the ad which must be selected to submit a ballot may be replaced by or augmented by an instant win game of chance. In this embodiment, the participant is motivated to enter the contest by selecting a game of chance to be played. The instant win game may award the participant tickets which may be entered into a prediction contest website raffle. In one embodiment, the instant win game is displayed before an advertiser website and before the countdown timer is displayed. In another embodiment, the instant win game may include advertising elements such that the instant win game replaces the advertisement and countdown timer discussed in blocks 224, 230, 232, 234 and 236. In this embodiment, once the instant win game is played, the participant's ballot is entered. In this way, the instant win game may expose the participant to an advertiser's message without requiring the participant to view a true advertisement or an advertiser's web page.

In another embodiment, the advertisement and countdown timer discussed in blocks 224, 230, 232, 234, 236, and 246 may be skipped such that submission of a ballot is accepted by clicking on a submit ballot button or other similar user interface item, so long as one or more required survey questions is completed in the ballot. In this way, the participant provides information in the form of responses to survey questions in exchange for being allowed entry into a contest for the opportunity to win a prize. In this embodiment, the prediction contest website may include survey questions as requested by a third party such as a manufacturer or service provider. In this way, the prediction contest website may earn income from third parties for conducting targeted surveys based on participant profile information. That is, based on the participant profile information maintained by the prediction contest website, survey questions may be included in ballots to participants meeting certain third party specified requirements so that the third party may obtain responses to survey questions it provides to the prediction contest website. The prediction contest website may earn income from third parties for providing this service.

FIG. 2C illustrates a flow of actions taken to process a prediction contest ballot according to an embodiment of the prediction contest website described herein. The prediction contest website receives numerous ballots for prediction contests and stores the ballot information in a ballot database, as shown in block 260. In one embodiment, the prediction contest ballots may be stored using well known database techniques. In one embodiment, there may be a separate ballot processing module or section of software that handles the ballot storage, retrieval and other ballot processing tasks associated with the prediction contest website. The processing continues to receive and process ballots until the contest has closed, as shown in block 262. A prediction contest closes at an appointed date and time as set by a prediction contest website manager. Event result data is received by the prediction contest website when the one or more events included in a contest ballot are over or have ended, as shown in block 264.

In one embodiment, the prediction contest website provides an interface by which a website manager, operator or administrator may enter the results of and other data concerning games, matches, etc., that are included in prediction contests offered on the website. That is, the event result data is entered by hand. As such, the prediction contest manager is required to regularly, and typically daily, enter the outcomes, scores, and other data regarding the sporting events that are the subject of the prediction contests offered on the prediction contest website. In another embodiment, the prediction contest website may receive a data feed from one or more third parties that automatically provide sporting event data upon the conclusion of sporting events. In this way, the prediction contest website may subscribe to one or more third party sports data services to automatically obtain sports events results data and related data which are used by the prediction contest website to determine prediction contest winners and to award tickets to participants.

The prediction contest website compares the predictions and responses to tie breaker questions of each of the ballots for a closed contest with event result data, as shown in block 266. Based on this comparison, a winning ballot is selected and tickets are awarded to entered participants, as shown in block 268. A winning ballot is that ballot that is the best ballot or is a perfect ballot, depending on the configuration of the contest. When multiple best ballots or perfect ballots are found, the tie breaker questions are used to determine a winner. It is possible that in some circumstances there may be more than one winner. In these situations, a random drawing may be held to select a single winner, the prize may be split, or multiple prizes of the same value may be awarded, depending on the rules made known to the participants by the prediction contest website. In one embodiment, tickets are awarded to those participants based on the number of correct predictions in the participant's ballot. That is, in one embodiment, if five games on the ballot are correctly predicted, five tickets are added to the participant's available tickets. In one embodiment, different numbers of tickets may be awarded for selecting a winner versus predicting a tie, and different numbers of tickets may be awarded based on odds or favorites. In some embodiments, the participant may also be awarded one ticket for each correct response to a tie breaker question. In various embodiments, the number of tickets awarded per correct prediction or tie breaker question response may vary.

In one embodiment, the winner of a contest may, in addition to the prize awarded for winning a prediction contest, be provided a bonus number of tickets corresponding based on a winning ballot multiplier. That is, a multiplier M may be applied to the total of the number of correct predictions. For example, if the top ten players in the U.S. Open men's tennis matches are selected, the winner may receive 10·M tickets. In one embodiment, M may be 100 such that, in this example, the contest winner is awarded 1000 tickets. In another embodiment, the multiplier may be applied to the total tickets won on the ballot, including the correct answers to tie breaker questions.

A congratulatory email and a results email communication are prepared and sent, as shown in block 270. In one embodiment, the prediction contest website software includes an email processing component. In one embodiment, after each of the following occurrences, the prediction contest website sends an email communication to a participant. These email notes may be referred to as event responsive communications. When a participant registers with the prediction contest website, a welcome email note is sent. When a participant successfully submits a ballot, a confirmation copy of the entered ballot is sent. When a participant fails to successfully submit a ballot, a notification may be sent identifying the sports league and the ballot and stating that the ballot was not entered and should be resubmitted. After a contest in which the participant submitted a ballot has closed and the events included in the ballot have concluded, a results email is sent notifying the participant of the results of those events included in the ballot and informing the participant of the number of tickets the participant has accumulated resulting from the particular ballot. The participant's prediction accuracy and percentile for this ballot may also be included in this email note. In addition, the participant's overall tickets won, overall accuracy and overall percentile may be included in this email note. When the participant has entered a ballot that wins a contest, a congratulatory email note is sent informing the participant of the prize awarded. Additional and fewer email notes may be sent in accordance with and not departing from the invention described herein. In one embodiment, any email to participants may include advertisements directed to the participant based on the participant profile. The prediction contest website may earn income for the placement of such advertisements.

In addition to the event responsive communications sent by email to participants of the prediction contest website, direct marketing advertisements and solicitations may be sent to the participants. In one embodiment, during participant registration with the prediction contest website, the participant may choose to receive email from sponsors or other entities. In another embodiment, survey questions included in the prediction contest ballot may ask the participant whether the participant is interested in and would like to receive email about a particular product, store, etc. Should the participant respond affirmatively, the prediction contest website may send an advertisement, solicitation or other information described in the survey to those participants who responded affirmatively to the survey question. In various embodiments, the prediction contest website may earn income based on the advertisement, solicitation and related email communications sent on behalf of third parties. Participant profiles may be used to direct such email advertisements to participants meeting advertiser specified criteria. In another embodiment, the prediction contest website may provide lists of prediction contest website participants who either agreed to receive third party ads and solicitations and who responded affirmatively to a survey question. The prediction contest website may also allow for automated opt-in participant co-registration with other websites, such as in response to survey questions or responses to registration questions.

FIG. 3 illustrates an example prediction contest main web page according to an embodiment of the invention described herein. Prediction contest main web page 300 and all of the web pages described herein and presented by the prediction contest website may include various well known user interface items such as text, graphics, hypertext links, text entry fields, pull-down menu items, check off circles, check off boxes, animation, flash program elements, JAVA® applets, and the like. In one embodiment, main web page 300 may include a listing or representation of each of the sports leagues for which prediction contests may be pending. The sports leagues such as MLB, MLS, NASCAR, NCAA football, and the like may be represented as sports league graphics 302. In one embodiment, the graphics representing the sports leagues may include logos for particular sports leagues. Adjacent to the sports league listing is a listing that includes those prizes which may be won when participating in a prediction contest regarding the particular league, as shown by prizes 304. For example, winning the MLB prediction contest may result in $100.00 or more being awarded to the winner. That is, based on the method described herein, the prize may increase in value based on the number of ballots received. Prediction contest main web page 300 may also include a sample ballot 306 and ballot closing data 308. Depending on a particular sport, a ballot associated with the sport will have a ballot closing time a certain amount of time before the first event included in the ballot is set to begin. For example, if the sport league is MLB or NBA, the ballot may refer to games played on a particular day such that the ballot will close before the first game is begun on that day. As such, in the example shown in ballot closing data 308, MLB has a closing time of 3:00 a.m. during the day on which the games will be played. Some contests may span various events over a weekend or other period of time.

The prediction contest main web page 300 may include a name of the provider of the prediction contest such as shown by name 310. Instructions which describe how the prediction contests are played may also be included in the prediction contest main web page as text 312. Other features accessible to a viewer of the prediction contest main web page include current prize information as denoted by a dollar sign graphic 322, a number 324 representing the leaderboard features of the website, a graphic 326 representing a link to the group play feature, and a question mark graphic 328 which provides a frequently asked questions or help page. In addition, the prediction contest main web page may provide information such as the name of the current user if the user is logged in, represented by user name text 330, the number of tickets available for the logged in user to use in a raffle, if any, as shown by tickets text 332, and a graphical image or text which allows the user to either log in or log out, as shown by log out text 340. In one embodiment, the sports leagues represented by sports league graphics 302 may change to a particular color such as white when the current prediction contest ballot for that league has already been played. In one embodiment, the sports league graphic for a league or sport may be displayed as white and/or distinguished in some way when the league or sport is out of season or when no games or events are pending. When a prediction contest ballot for an in season sport has not been played, it displays a color associated with that prediction contest or league. When a sports league graphic is selected by clicking or otherwise activating a link associated with the sports league logo, a prediction contest ballot is provided regarding the selected sports league. Similarly, a contest ballot may also be provided when the participant clicks on the sports league acronym in ballot closing data 308.

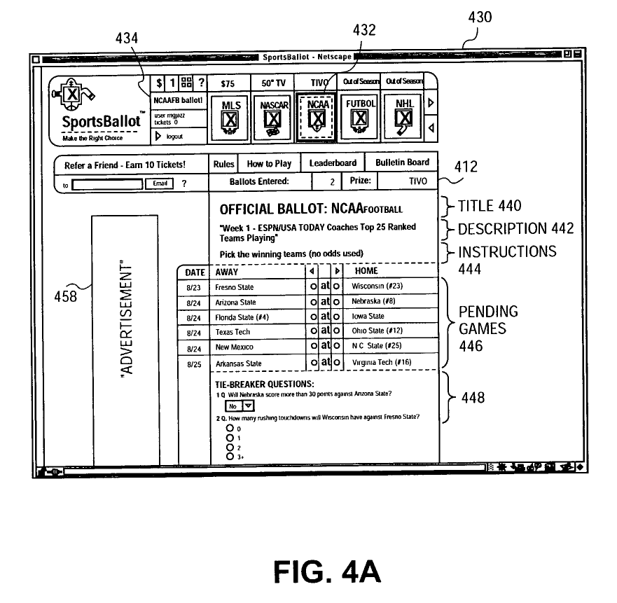

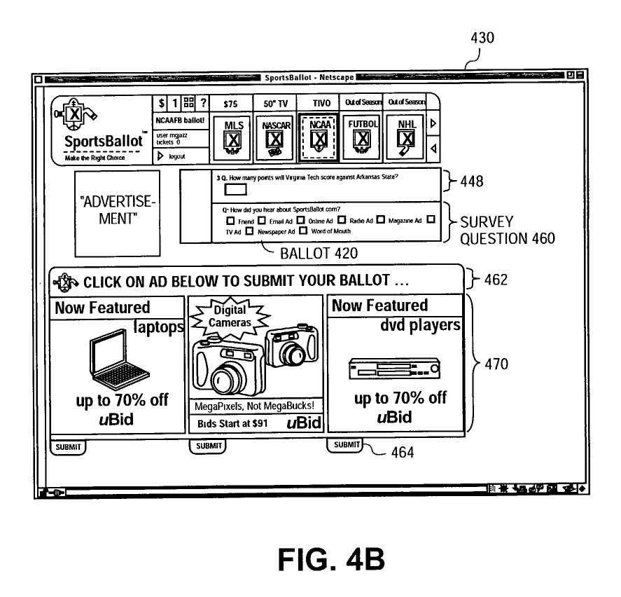

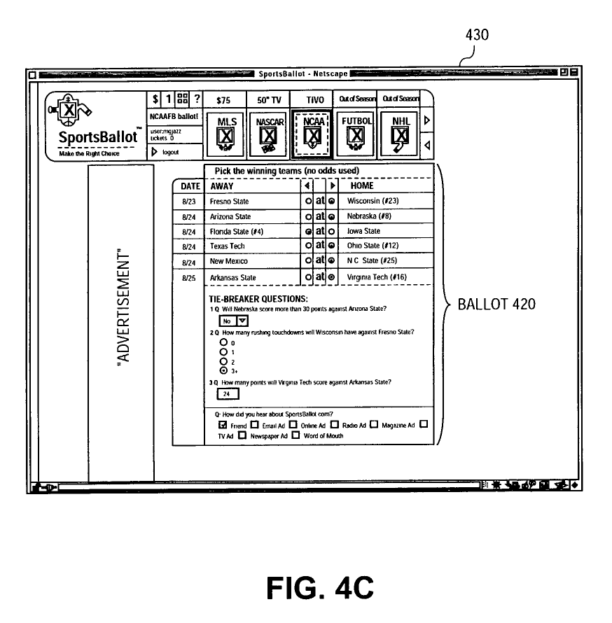

FIGS. 4A, 4B, and 4C illustrate an example prediction ballot web page according to an embodiment of the invention described herein. After a participant selects a sports league for which a ballot should be provided, the prediction contest website provides a prediction contest ballot for the particular sport in a prediction contest ballot web page. In the example shown in FIG. 4A, an NCAA ballot has been selected as denoted in multiple places on web page 430. When a sports league graphic has been selected to request a prediction contest ballot, the sports league graphic is distinguished in some way from the other sports league graphics, such as by highlighting the graphic or somehow making the graphic stand out. In addition, the name of the ballot is provided in a text area such as text area 434. Ballot 420 may include three sections. A top section of the ballot may include a title 440 and a description 442 of the events included in the ballot, and general instructions 444 regarding the ballot. A middle section of the ballot may include pending events in the form of pending games 446 of the selected sports league. In this example, the ballot is for NCAA football, and the pending games are the preseason NCAA football games for the weekend of Friday, August 23 through Sunday, August 25. The middle section may contain information about the events such as which team is the home team, which team is the away team, and the date of the event. Other information such as rankings, seeds, etc. may be included in the middle section of the ballot regarding each of the teams or participants in the event. This NCAA football ballot is an example of the format of a ballot which may be similarly used for other team league sporting events such as baseball, basketball, and soccer. However, for those contests which involve single participants rather than teams, a ballot may be used which requires the participants to select the sequence of finishers in a race, open, or other event, such as for NASCAR, professional tennis, cycling, and the like. A bottom section of the ballot may include two kinds of questions, tie breaker questions 448 and survey questions 460. Depending on the kind of event prediction contest, the winner may be a participant who submitted a perfect ballot or a best ballot. In those situations when there are multiple winning ballots, the tie breaker questions are used to break the tie. In various embodiments, one or more tie breaker questions may be used. In one embodiment, tie breaker questions are in some way associated with the events included in the ballot. For example, as shown in ballot 420, one of the tie breaker questions 448 refers to yards rushed in one of the football games included in the ballot. If multiple winners remain after evaluation of the tie breaker questions, a random drawing may be held to select a single winner.

In addition, as part of a funding mechanism for the prediction contest website, the bottom portion of the ballot includes one or more survey questions which may be used by the prediction contest website to earn income by using the acquired data in marketing to the participants of the website and for directed advertising to the participants of the website. The results of the survey questions may be used to direct email offers and solicitations to participants in the prediction contest website, and may also be used to determine which ads are served to the participant while the participant is viewing various web pages on the prediction contest website. In another embodiment, the survey questions may be directed to participants based on responses to prior survey questions, and information provided during registration as maintained in the participant profile. In this way, the prediction contest website may earn income from entities who wish to conduct surveys directed to persons having certain characteristics or matching a certain profile. Further, the survey may ask whether the participant is interested in participating in a specified kind of survey. In this way, the prediction contest website may present surveys as part of contest ballots to willing survey participants on behalf of an entity in exchange for a fee.

Advertisements may be placed in one or more locations on a web page that includes the prediction contest ballot. For example, advertisement 458 may be placed to the left of a prediction contest ballot. In other embodiments, one or more ads may be placed to the left, to the right, and to the top of the prediction contest ballot. The dimensions of the ad space on the left, top, and right of the prediction contest ballot may be any size well known to those skilled in the art and may conform to well known Internet advertising standards. In addition to any ads placed on the left, right, and above the prediction contest ballot, one or more advertisers or advertisements are placed below the prediction contest ballot. One of the advertisements below the ballot may be clicked on by a participant to submit the ballot and enter the prediction contest. These advertisements, like the advertisements to the left, above, and to the right of the prediction contest ballot, may be in an Internet standard size. Advertisements 470 appearing below the prediction contest ballot 420 may be accompanied by text or graphics which direct a participant to click on or otherwise activate an advertisement associated with an advertiser depicted in one of the ads. For example, graphic 462 may instruct a participant to “click on an ad below to submit your ballot”, and graphic 464 may also be provided which instructs the user to click on the graphic to submit the prediction contest ballot. In one embodiment, each of three advertisements 470 below the ballot may be from different sponsors. In the example shown in FIG. 4B, all three advertisements 470 are from a single advertiser. In one embodiment, all advertisements on a ballot web page may be from a single advertiser resulting in a sponsored ballot.

The prediction contest website may earn income from the advertisers whose ads are placed on prediction contest website web pages based on well known formulas and techniques. These well known techniques include, for example, a certain sum per participant view of an advertisement such as cost per thousand impressions (known as CPM), a certain sum per participant click through of an advertisement (known as cost per click or CPC), a sum per each participant registration at an advertiser website (known as cost per lead or CPL), a sum per each participant purchase from an advertiser website (known as cost per action or CPA), a sum amounting to a portion of purchases made by participants from an advertiser website which may be referred to as a commission, and the like.

FIG. 4C illustrates the prediction contest ballot 420 in a filled-out state. To submit the filled-out prediction contest ballot, the participant must click on or otherwise activate one of the ads placed below ballot 420, such as advertisements 470 or the instructional text or graphics associated therewith such as graphics 462 and 464. Although the advertisements which must be clicked on to submit the prediction contest ballot are located below the prediction contest ballot in the example web page shown in FIG. 4B, the ad which a participant is required to click on to submit the prediction contest ballot may be located to the left, to the right, above, or below the prediction contest ballot in various embodiments.

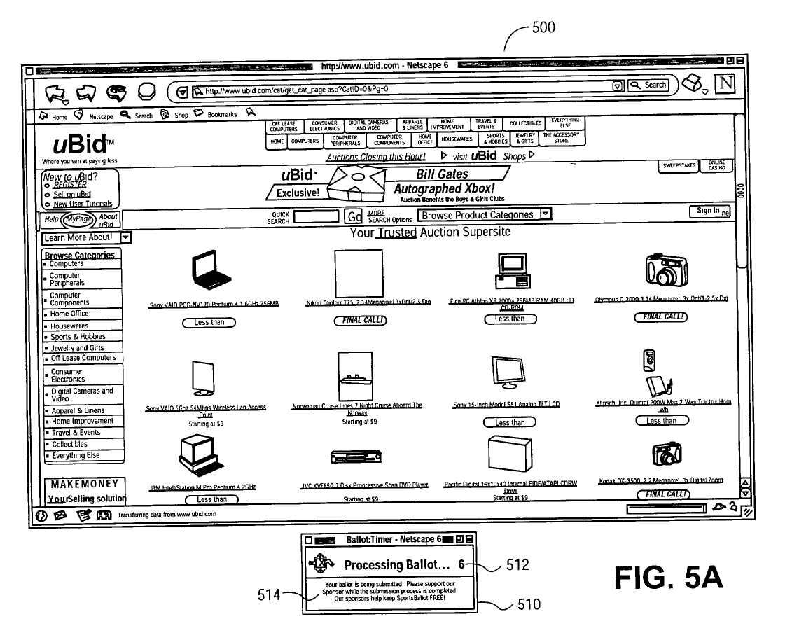

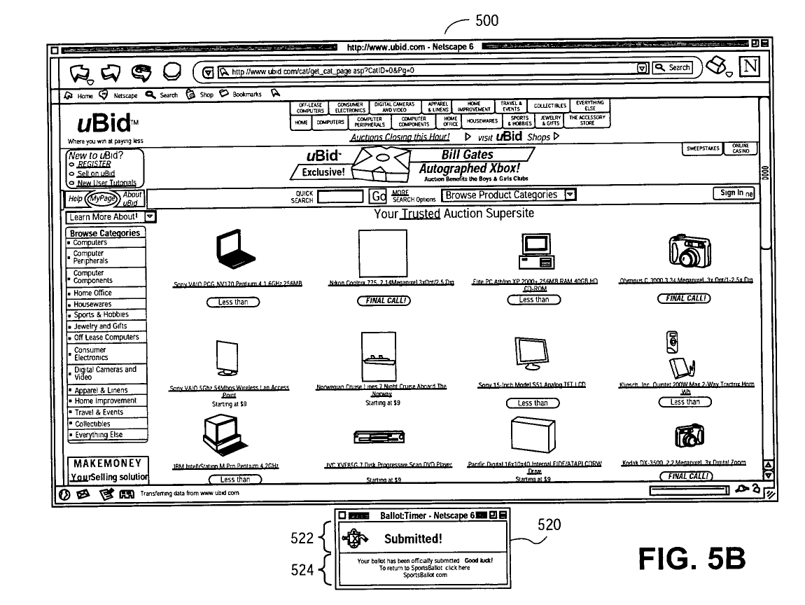

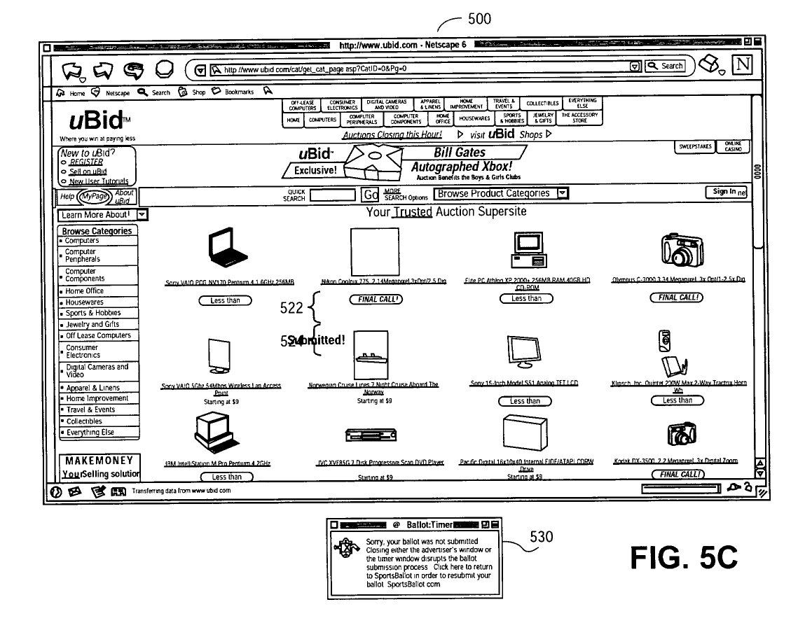

FIG. 5A illustrates an advertiser website accompanied by a countdown timer window according to an embodiment of the invention described herein. After a participant clicks on an advertisement to submit the prediction contest ballot, the participant is redirected to a website associated with the advertiser, such as web page 500. In one embodiment, the web page may be a simple web page from a website which describes various products or services offered by the advertiser. In another embodiment, the web page to which the participant is directed may provide a flash animated advertisement, a streaming video advertisement, or other form of still or moving advertisement. A countdown timer window 510 is provided adjacent to the advertiser's web page. In one embodiment, the countdown timer window 510 may include text 514 describing that the prediction contest ballot is being processed. Countdown timer window 510 may also include a decrementing counter 512 which shows the time remaining during which the participant must continue viewing the window associated with the advertiser's web page or other advertisement for the ballot to be entered into the contest. When the timer has decremented to zero, the countdown timer window is closed and a ballot submitted notification window 520 is displayed.

FIG. 5B illustrates a ballot submitted notification window according to an embodiment of the invention described herein. Ballot submitted window 520 may be displayed adjacent to or on top of advertiser's web page 500. The ballot submitted window may include text 522 which states that the ballot has been submitted, and additional text 524 which instructs the participant to click on the window to return to the prediction contest website.

The advertisements included in the prediction contest ballot web page as well as the advertisement displayed after the participant submits the prediction contest ballot may be served by a third party entity unaffiliated with either the advertiser or the entity providing the prediction contest. That is, according to well known Internet techniques, advertisements may be served via links or connections to third party advertisement servers. In another embodiment, the advertisements may be served by the advertiser.

FIG. 5C illustrates a ballot not submitted notification window according to an embodiment of the invention described herein. If the participant closes either the advertisement window or the timer window, the prediction contest server displays a ballot not submitted window 530 which informs the participant that the ballot has not been submitted. In one embodiment, the prediction contest server saves the completed but unsubmitted ballot and reminds the participant during a future login to the prediction contest website that an unsubmitted ballot exists. In this embodiment, the prediction contest website may provide the participant the opportunity to submit the completed but not submitted ballot by clicking on a resubmit button or other user interface item provided in a “submit completed ballot” notification window.

FIG. 6A illustrates a raffle web page according to an embodiment of the invention described herein. Raffle web page 610 may include one or more raffle prizes 620. Each raffle prize may include a graphical depiction of the prize such as prize graphic 622, a text description of the prize such as prize description 624, a raffle end date such as close date 626, and the number of tickets that have been submitted as entries to the raffle for the particular prize such as ticket tally 618. By providing all of this information, a participant may select a prize which may both maximize the participant's chances of winning as well as selecting a prize which is most interesting to the participant. In addition, a detailed description of a prize may be provided when a participant clicks on prize graphic 622 or icon 628. Further, in another embodiment, a buy button or similar user interface item may be included for each prize according to well known techniques. In this way, a participant may purchase a desired prize, and the prediction contest website may earn income in the form of a commission from the purchase.

A participant may enter a raffle by typing the number of tickets into text entry box 612 and clicking submit button 614. User interface text items such as ticket tally 618 may be updated based on the number of tickets entered into the raffle for the particular prize by all participants, and the number of tickets submitted by the logged in participant 616 may be updated based on the number of tickets submitted by the participant in the particular raffle. When a participant selects a raffle prize and enters a raffle, in addition to updating the raffle database, the prediction contest website updates the participant database and the participant profile for the current participant. In this way, various characteristics regarding the participant may be maintained and later used for marketing purposes such as directing advertisements that correspond to the participant's raffle choices or directing electronic mail advertisements or solicitations to the participant which correspond to the raffle prize selections made by the participant. In one embodiment, a raffle winner is chosen at random from all entrants to the particular raffle. Upon winning a raffle, a raffle winner notification email is sent to the winning participant informing the participant of the prize won and providing instructions to follow to claim the prize.

FIG. 6B illustrates a leaderboard web page according to an embodiment of the invention described herein. The leaderboard web page 630 may include a table in a well known format such as leaderboard table 640. Leaderboard table 640 may include a header such as text 642 which informs the viewer that a leaderboard is being presented. Via a user interface item such as pull-down menu 662, the participant may select from those offered sports leagues or other event categories for which the leaders will be displayed. In a leftmost column, a listing of top leaders 646 may be provided. In adjacent columns, the total number of tickets 650 won by each of the leading players, the accuracy 652 of the predictions of each of the leading players, and the home town 658 of each of the leading players may be provided. The leaderboard may be sorted by clicking on a heading of the leaderboard table such as total tickets header 654 and accuracy header 656. In this way, the most accurate participants may be viewed in order or the participants having won the most tickets may be viewed in order. In addition to pull-down menu 662, heading text 644 may reflect the participant selection of a particular league or all leagues of sporting events listed. Further, a participant may view his or her ranking by selecting a user interface item stating “view my ranking” such as graphic 660. Upon selecting “view my ranking”, the prediction contest website presents only the name of the currently logged in user in the left column. The participant may then view the total tickets won and accuracy of the participant's predictions for each of the sports leagues available via the prediction contest website or all of the sports presented via the prediction contest website by using pull-down menu 662. Although a four column table is provided, additional or fewer columns may be provided in other embodiments of the leaderboard table.

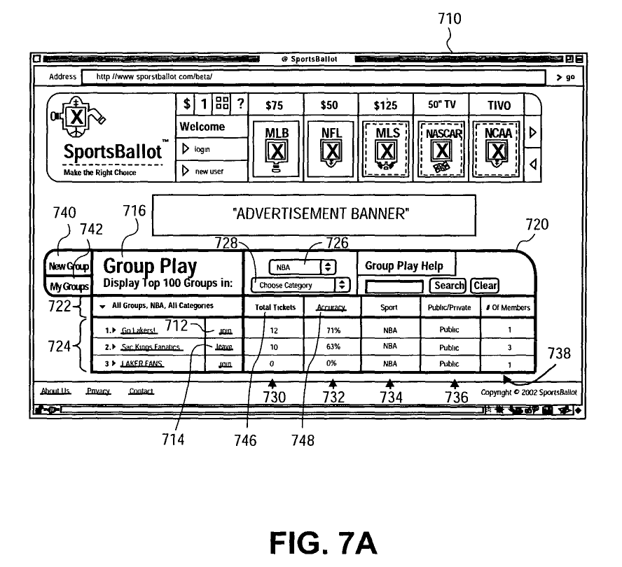

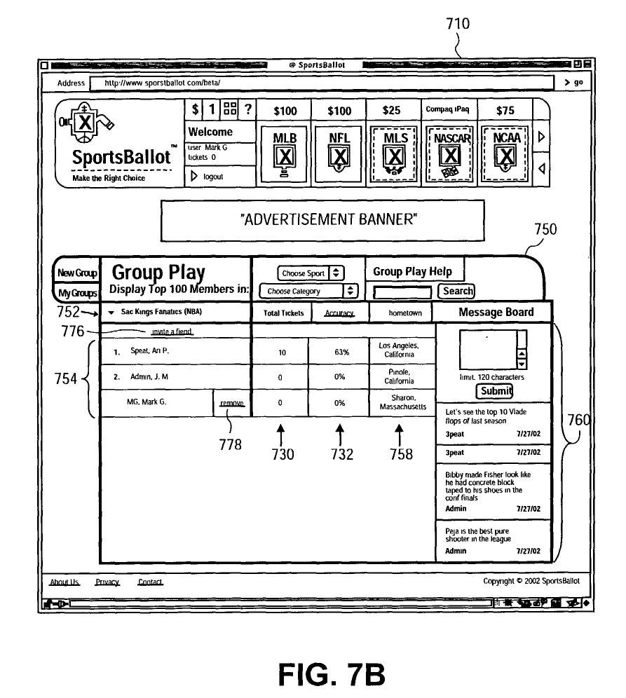

FIGS. 7A and 7B illustrate a group play web page according to an embodiment of the invention described herein. Group play web page 710 may include a header such as text 716 which informs the viewer that group play information is being presented. Group play web page 710 may include a group play table 720 which lists, depending on participant selections, all groups available to participants in the prediction contest website, or those groups in which the participant is a member. Table 720 provides a list of all those groups available via the prediction contest website. The prediction contest website may allow a user to select those groups regarding a particular sports league by pull-down menu 726 or select a particular category of groups such as by pull-down menu 728. In the example presented in FIG. 7A, all groups regarding the NBA are presented. This can be seen by heading text 722 which provides the sports league and specifies whether all groups or the groups of which the participant is a member are listed. The leftmost column of table 720 provides a listing of group names 724. Other columns in the group play table 720 include total tickets column 730, accuracy column 732, sport column 734, public/private column 736 and number of members 738. Total tickets column 730 lists the total number of tickets won by members of a particular group. Accuracy column 732 provides the percentage of predictions that are accurately made by the members of a particular group. Sport column 734 provides a shorthand version of the sport in which the group participates. Public/private column 736 provides a designation of whether the group is available to the general public for membership or whether the group is a private group. Number of members column 738 provides a total of the number of members of a particular group. The groups may be sorted by clicking on text links associated with total tickets column 730 and accuracy column 732. More specifically, as shown in the example in FIG. 7A, the groups are currently listed according to the total tickets, as designated by total tickets text 746. Accuracy text 748 may be selected to view the groups according to the percentage of accurate predictions for the members of the group. The group play web page 710 also provides participants the opportunity to construct new groups by selecting graphic or text item 740 and to view groups in which the particular participant is a member by selecting my groups user interface item 742. A participant may join a group by selecting join text 712 adjacent to a group name. Leave text 714 is displayed adjacent to those group names of which the participant is currently a member so that the participant may remove himself or herself from the group.

To view particular details regarding a group, the name of a group may be selected by a participant, such as by clicking on one of the underlined group names 724. Referring to FIG. 7B, group play table 750 displays information regarding a particular group, in this example, the group has the name “Sac Kings Fanatics (NBA)”. This is shown by text 752 in the leftmost column of table 750. The current members of the group are shown by group member text 754. If the participant is a member of the group, the participant may invite a friend to join the group by sending an email message by selecting “invite a friend” text 776. A participant may remove himself or herself from a group by selecting remove text 778. In addition to the total tickets won by the members in the group and the accuracy of the predictions of the members of the particular group, as shown by columns 730 and 732 in table 750, the home town of each of the members is also presented, as shown by home town column 758. An additional feature of the group play web page is a message board 760 which allows members of the group to discuss whatever the subject of the particular group is. For example, in the example presented in table 750, the messages discuss the NBA team the Sacramento Kings, as shown by the contents of the messages within message board 760. The message board may include text, buttons, and a text entry field as well as other user interface items known to those skilled in the art.

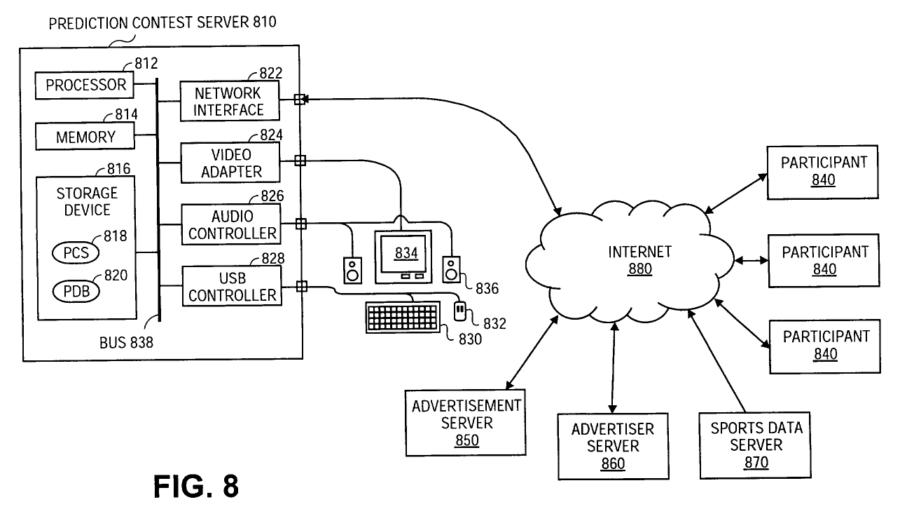

FIG. 8 illustrates an environment in which an embodiment of the prediction contest described herein may be implemented. The methods disclosed herein may be implemented in software, hardware, and a combination of software and hardware such as firmware. The invention described herein may be implemented as software such as prediction contest software (PCS) 818, which may include one or more processes, modules, subroutines, etc. included in one or more files to achieve the processes and methods described herein. In one embodiment, the PCS may include a ballot processing module, a raffle processing module, an email processing module, an administration module, a data mining module, and other or fewer modules to achieve the methods and processes described herein.

In one embodiment, PCS 818 may run on prediction contest server computer 810. Prediction contest server computer 810 includes processor 812 and memory 814. In one embodiment, PCS 818 may be executed by processor 812. Processor 812 may be any computer processor or microprocessor, such as, for example, an Intel® Pentium® 4 processor available from Intel Corporation of Santa Clara, Calif., and memory 814 may be any random access memory (RAM). Input from prediction contest managers or operators may be received via Universal Serial Bus (USB) controller 828 to which user input devices such as keyboard 830, mouse 832, trackball (not shown), pen and tablet (not shown), etc. are connected. Audio may be presented via audio controller 826 to which speakers 836 are connected. Graphics, images, video and text may be presented by video adapter 824 to which display 834 is coupled. Network interface 822 may be an analog modem, a cable modem, a digital modem, a network interface card, and other network interface controllers that allow for communication to the Internet 880 via a wide area network (WAN), via a local area network (LAN), via well known wireless standards, etc.

In one embodiment, PCS 818 in the form of computer instructions may be stored on storage device 816 which may be a hard disk drive. In another embodiment, PCS 818 may be downloaded via Internet 880 or other WAN or LAN through network interface 822 to server computer 810 and stored in memory 814 and/or storage device 816. In various embodiments, storage device 816 may be any machine readable medium, including magnetic storage devices such as hard disk drives and floppy disk drives, optical storage devices such as compact disk read only memory (CD-ROM) and readable and writeable compact disk (CD-RW) devices, readable and writeable digital versatile disk (DVD) devices, RAM, read only memory (ROM), flash memory devices, stick memory devices, electronically erasable programmable read only memory (EEPROM), and other silicon devices. In various embodiments, one or more machine readable media may be coupled locally, such as storage device 816, or may be accessible via electrical, optical, wireless, acoustic, and other means from a remote source, including via a network.

A participant database (PDB) 820 may be maintained by the PCS and stored on storage device 816, and, in some embodiments, in addition to or in place of storage device 816, on one or more local or remote storage devices. In addition, the PCS and its constituent modules, may maintain a ballot database, a raffle database, and other databases in addition to the participant database. In one embodiment, the participant database may include these other databases. When there are multiple databases, they may be linked via relational technology known to those skilled in the art. To support the participant database and other databases, database software that supports the structured query language (SQL) and/or other well known database languages may be included on storage device 816.

In one embodiment, each of processor 812, memory 814, storage device 816, USB controller 828, audio controller 826, video adapter 824, and network interface 822 are coupled to bus 838, by which each of these devices may communicate with one another. In various embodiments, two or more buses may be included in server computer 810. In addition, in various embodiments, two or more of each of the components of server computer 810 may be included in server computer 810.

It is well known that server computer 810 includes an operating system (not shown) such as Microsoft(t Windows® 2000 Server available from Microsoft Corporation of Redmond, Wash., also stored on storage device 816. The operating system, other software, and additional hardware components of server computer 810 are not depicted and are not discussed because they are well known to those skilled in the art and so not as to distract from the invention described herein.

In one embodiment, server computer 810 may be implemented as two or more computers arranged as a cluster, group, local area network (LAN), subnetwork, or other organization of multiple computers according to well known techniques. In addition, when comprised of multiple computers, the server computer group may include routers, hubs, firewalls, and other networking devices. In this embodiment, the group may include multiple specialized servers such as, for example, graphics servers, audio servers, database servers, transaction servers, applications servers and the like.

In one embodiment, a user of a computing device such as a personal computer, personal digital assistant (PDA), cellular telephone, computing tablet, portable computer, and the like and shown as participant device 840 may allow a participant to connect to and access the prediction content website served by prediction contest server 810 by communicating over Internet 880 according to well known techniques. In one embodiment, participant device 840 may have a configuration similar to server computer 810. In various embodiments, a participant device may be capable of communicating via the Internet using electrical, optical, wireless, acoustic, and other means according to any well known communications standards, including, for example, USB via USB controller 530, IEEE 1394 (more commonly known has I.Link® and Firewire®), IEEE 802.11, Bluetooth™, and the like. Participant device 840 should be equipped with an Internet web browser such as, for example, Netscape Communicator 6.2 available from Netscape Communications Corporation of Mountain View, Calif., or similar software to allow for access to the prediction contest website.

In one embodiment, server computer 810 may rely on one or more third parties to provide or serve advertisements that are displayed on various web pages by the PCS, such as advertisement server 850. Similarly, in another embodiment, advertiser server 860 may provide the advertiser web page or serve advertisements which may be included in the web pages of the prediction contest website as described above. Further, in one embodiment, sports data server 870 may provide sports event results and sports events data to the PCS. In this way, the PCS may subscribe to a sports data service provided by a third party which maintains sports data server 870.

Although the discussion herein was focused on a website that provides a prediction contest, the systems and method described herein may be implemented for any kind of contest, such, for example trivia contests and other skill based contests where the winners of a contest are determined by other than random means.

In the foregoing specification, the invention has been described with reference to specific embodiments thereof. It will be evident that various modifications and changes can be made thereto without departing from the broader spirit and scope of the invention as set forth in the appended claims. The specification and drawings are, accordingly, to be regarded in an illustrative rather than a restrictive sense.

1. A method comprising:
providing a ballot for a prediction contest regarding a plurality of future events to a participant;
requiring the participant to answer at least one survey question included in the ballot as a prerequisite to entering the ballot into the prediction contest;
maintaining a participant profile based on at least the survey questions included in the prediction contest ballot; and
selecting a winner of the prediction contest after the conclusion of all of the future events, the selecting based on correct event outcome predictions.

2. The method of claim 1 further comprising:
increasing a value of a prize to be awarded to a winner of the prediction contest based on the number of ballots entered in the prediction contest.

3. The method of claim 1 further comprising:
receiving income from an entity for including an entity requested survey question on the prediction contest ballot.

4. The method of claim 1 wherein the providing further comprises:
displaying advertisements based on participant profile data received in response to survey questions included in earlier participant submitted ballots.

5. The method of claim 4 further comprising:
requiring the participant to select and view one of the advertisements for a time period as a prerequisite to entering the prediction contest ballot into the prediction contest.

6. The method of claim 4 further comprising:
receiving income from an advertiser for displaying an advertiser specified advertisement as one of the advertisements.

7. A method comprising:
offering at least one event prediction contest over a network;
providing a prediction contest ballot and at least one advertisement to a participant responsive to a ballot request received from the participant over the network;
receiving over the network a participant selection of an advertisement to submit a completed prediction contest ballot;
presenting a participant selected advertisement to the participant for a time period; and
entering the completed prediction contest ballot in the prediction contest after the advertisement has been displayed to the participant for the time period, and not entering the prediction contest ballot if the participant disengages the advertisement before the time period expired.

8. The method of claim 7 wherein the prediction contest has a prize associated therewith, the prize increasing in value based on a number of ballots entered.

9. The method of claim 7 wherein the prediction contest ballot includes at least one survey question which must be answered as a prerequisite to the entering.

10. The method of claim 7 wherein the prediction contest is a best ballot contest.

11. The method of claim 7 wherein the prediction contest is a perfect ballot contest.

12. The method of claim 7 wherein the prediction contest ballot includes at least one tie breaker question.

13. The method of claim 7 further comprising:
awarding a prize to at least one participant that successfully predicts the outcome of all events included in the prediction contest ballot.

14. The method of claim 7 further comprising:
awarding a prize to at least one participant who successfully predicts more events included in the prediction contest ballot than all other participants.

15. The method of claim 7 further comprising:
awarding tickets to the participant based on a number of correct predictions made on the prediction contest ballot; and
awarding a prize to at least one participant who submitted the prediction contest ballot that earns more tickets than all other participants.

16. The method of claim 7 further comprising:
awarding tickets to the participant based on a number of correct predictions made on the prediction contest ballot; and
providing at least one raffle which accepts the tickets for entry.

17. The method of claim 7 wherein the presenting is based on participant data collected in response to answers to survey questions provided in other prediction contest ballots the participant submitted.

18. The method of claim 7 further comprising:
maintaining a participant profile based on participant registration information and at least one of participant responses to survey questions included in the prediction contest ballot, participant raffle entries, and participant ballot selections.

19. The method of claim 7 further comprising:
receiving income from advertisers based on the participant selection of the advertisement.

20. The method of claim 7 further comprising:
receiving income from advertisers based on the number of ballots submitted.

21. The method of claim 7 further comprising:
receiving income from advertisers based on a number of participants who make purchases from the advertiser.

22. The method of claim 7 further comprising:
receiving income from advertisers based on a value of participant purchases made from the advertiser.

23. The method of claim 7 further comprising:
receiving income from advertisers based on a number of participants who register with the advertiser.

24. A system comprising:
a storage device, a memory, and a processor each coupled to a bus;
the storage device having instructions which when executed by the processor cause the system to perform actions including:
providing a ballot for a prediction contest regarding a plurality of future events to a participant;
requiring the participant to answer at least one survey question included in the ballot as a prerequisite to entering the ballot into the prediction contest;
maintaining a participant profile based on at least the survey questions included in the prediction contest ballot; and
selecting a winner of the prediction contest after the conclusion of all of the future events, the selecting based on correct event outcome predictions.

25. The system of claim 24 wherein the storage device has further instructions stored thereon which when executed by the processor cause the system to perform further actions including:
increasing a value of a prize to be awarded to a winner of the prediction contest based on the number of ballots entered in the prediction contest.

26. The system of claim 24 wherein the storage device has further instructions stored thereon which when executed by the processor cause the system to perform further actions including:
receiving income from an entity for including an entity requested survey question on the prediction contest ballot.

27. The system of claim 24 wherein the providing further comprises:
displaying advertisements based on participant profile data included in the participant profile based on responses to survey questions included in earlier participant submitted ballots.

28. The system of claim 27 wherein the storage device has further instructions stored thereon which when executed by the processor cause the system to perform further actions including:
requiring the participant to select and view one of the advertisements for a time period as a prerequisite to entering the prediction contest ballot into the prediction contest.

29. The system of claim 27 wherein the storage device has further instructions stored thereon which when executed by the processor cause the system to perform further actions including:
receiving income from an advertiser for displaying an advertiser specified advertisement as one of the advertisements.

30. A machine readable medium having instructions which when executed by a processor cause the processor to perform operations comprising:
offering at least one event prediction contest over a network;
providing a prediction contest ballot and at least one advertisement to a participant responsive to a ballot request received from the participant over the network;
receiving over the network a participant selection of an advertisement to submit a completed prediction contest ballot;
presenting a participant selected advertisement to the participant for a time period; and
entering the completed prediction contest ballot in the prediction contest after the advertisement has been displayed to the participant for the time period, and canceling the prediction contest ballot if the participant disengages the advertisement before the time period expired.

31. The machine readable medium of claim 30 wherein the prediction contest has a prize associated therewith, the prize increasing in value based on a number of ballots entered.

32. The machine readable medium of claim 30 wherein the prediction contest ballot includes at least one survey question which must be answered as a prerequisite to the entering.

33. The machine readable medium of claim 30 wherein the at least one prediction contest requires the participant to predict winners of a group of sporting events.

34. The machine readable medium of claim 30 wherein the prediction contest ballot includes at least one tie breaker question.

35. The machine readable medium of claim 30 having further instructions which when executed cause the processor to perform further operations comprising:
awarding tickets to the participant based on a number of correct predictions made on the prediction contest ballot; and
providing at least one raffle which accepts the tickets for entry.

36. The machine readable medium of claim 30 wherein the presenting is based on participant data collected in response to answers to survey questions provided in other prediction contest ballots the participant submitted.

37. The machine readable medium of claim 30 having further instructions which when executed cause the processor to perform further operations comprising:
maintaining a participant profile based on participant registration information and at least one of participant responses to survey questions included in the prediction contest ballot, participant raffle entries, and participant ballot selections.

38. The machine readable medium of claim 30 having further instructions which when executed cause the processor to perform further operations comprising:
earning income from advertisers based on the participant selection of the advertisement.

39. The machine readable medium of claim 30 wherein the network is the Internet.
